(19) United States
(12) Patent Application Publication
(10) Pub. No.: US 2015/0186454 A1
(43) Pub. Date: Jul. 2, 2015

(54) DEVICE AND METHOD OF PROVIDING PERSONALIZED MUSIC STREAMING SERVICE BY USING SOCIAL NETWORKING

(71) Applicant: HYUNDAI MOTOR COMPANY, Seoul (KR)

(72) Inventor: Dong Uk KIM, Incheon (KR)

(73) Assignee: HYUNDAI MOTOR COMPANY, Seoul (KR)

(21) Appl. No.: 14/546,983

(22) Filed: Nov. 18, 2014

(30) Foreign Application Priority Data
Dec. 26, 2013 (KR) 10-2013-0163624

(51) Int. Cl. G06F 17/30; H04L 29/06

(52) U.S. Cl. CPC G06F 17/30386; H04L 65/60; G06F 17/30091

(57) ABSTRACT

A device for providing a personalized music streamlining service by using a social networking service, includes a user musical taste extraction unit, a friend musical taste extraction unit, and a taste matching unit. The user musical taste extraction unit is configured to analyze and extract musical taste information of a user. The friend musical taste extraction unit is configured to extract musical taste information of a friend connected through the social networking service. The taste matching unit is configured to compare the musical taste information of the user with the musical taste information of the friend, extract common musical taste information based on a result of the comparison, and match the musical taste information of the user with the musical taste information of the friend.

### CROSS-REFERENCE TO RELATED APPLICATION

This application is based on and claims benefit of priority to Korean Patent Application No. 10-2013-0163624 filed Dec. 26, 2013, the entire content of which is incorporated herein by reference.

### TECHNICAL FIELD

The present disclosure relates to a device and a method of providing a personalized music streaming service by using social networking. More particularly, the present disclosure relates to a device and a method of providing a personalized music streaming service by using social networking, capable of providing a sharable music streaming service while establishing various friend channels in a mobile environment.

### BACKGROUND

Recently, a user can easily receive various music streaming services in a mobile or Internet environment, for example, a user can unilaterally receive a music streaming service through radio broadcasting, or receive a music streaming service immediately considering preference and taste of the user through an Internet radio.

Here, the music streaming service provided in a mobile or Internet environment means a service enabling a user to listen to music in real time without downloading a music file.

As an example of the related art, a general radio-type music streaming method is a music service in a broadcasting form of transmitting music in a unilateral direction, and has a disadvantage in that preference of a user is not considered.

As another example of the related art, the Internet radio method of immediately receiving a taste of a user and continuously updating a channel configuration may simply configure a channel considering only a taste of that user, thereby having a limitation in pursuing variety for satisfying musical demands of that user and his or her friends.

As another example of the related art, a content sharing method of receiving, by a user using a social network service, one or more contents (for example, a music file) from another user registered as a friend is disclosed in Korean Patent Application Publication No. 2011-52137. However, when a musical taste of the user is not matched with that of the friend, there is a disadvantage in that the user's demand for personally listening to music may not be satisfied.

Further, a user needs to search for one by one and register musical information currently provided in a social networking service as preference information, and needs to manually search for and register musical information, which is cumbersome, thus such content sharing method using the social networking service is not frequently used.

The above information disclosed in this Background section is only for enhancement of understanding of the background of the inventive concept and therefore it may contain information that does not form the prior art that is already known in this country to a person of ordinary skill in the art.

### SUMMARY OF THE DISCLOSURE

The present inventive concept provides a device and a method of providing a personalized music streamlining service by using social networking, which can analyze a musical taste of a user, match the analyzed musical taste of the user with various friend information of a social networking service and a musical taste of a friend to generate various friend channels, and provides a personalized music streaming service in a mobile environment (including a personal PC).

One aspect of the present inventive concept relates to a device for providing a personalized music streaming service by using social networking, including a user musical taste extraction unit, a friend musical taste extraction unit and a taste matching unit. The user musical taste extraction unit is configured to analyze and extract musical taste information of a user. The friend musical taste extraction unit is configured to extract musical taste information of a friend connected through a social networking service. The taste matching unit is configured to compare the musical taste information of the user and the musical taste information of the friend, extract common musical taste information and match the musical taste information of the user and the musical taste information of the friend.

The device may further include a channel configuration unit configured to generate and configure a streaming channel by utilizing the common musical taste information; and a music playing unit configured to execute and provide a music streaming by selecting the channel generated and configured by the channel configuration unit.

The device may further include a database (DB) storing the musical information extracted by the user musical taste extraction unit, the friend musical taste extraction unit, and the taste matching unit, and a taste selection unit configured to select musical information to be utilized for generating a streaming channel from the musical information stored in the DB.

The device may further include a channel/taste updating unit configured to adjust a sound source tendency of the channel generated and configured by the channel configuration unit by reflecting a taste of the user while streaming music through the channel, transmit the taste of the user to the user musical taste extraction unit, and update the taste of the user.

The device may further include a music streaming server configured to generate a music streaming based on information about the channel generated and configured by the channel configuration unit, and provide the generated music streaming to the music playing unit.

Another aspect of the present inventive concept encompasses a method of providing a personalized music streaming service by using a social networking service, including analyzing and extracting musical taste information of a user. Musical taste information of a friend connected through the social networking service is extracted by a friend musical taste extraction unit. The musical taste information of the user is compared with the musical taste information of the friend by a taste matching unit, and common musical taste information is extracted, and the musical taste information of the user is matched with the musical taste information of the friend. A streaming channel is generated and configured by utilizing the common musical taste information. The generated and configured channel is selected, a music streaming is executed, and music is played.

The method may further include storing, in a database (DB), the musical information extracted by the user musical taste extraction unit, the friend musical taste extraction unit, and the taste matching unit. Musical information may be selected to be utilized for generating a streaming channel from the musical information stored in the DB.

The method may further include adjusting a sound source tendency of the channel generated and configured by the channel configuration unit by reflecting a taste of the user while streaming music through the channel, transmitting the taste of the user to the user musical taste extraction unit, and updating the taste of the user.

The playing of the music may include generating a new music streaming channel in a music streaming server receiving channel information, and providing and playing music selected by a user through the new music streaming channel.

The matching of the musical taste information of the user with the musical taste information of the friend may include comparing the musical taste information of the user and the musical taste information of the friend in an order of an artist, music, a genre, and recently listened music.

Through the aforementioned technical aspects, the present inventive concept may have the following effects.

First, it is possible to configure a user-desired personalized music streaming channel by generating a channel of a friend sharable with the user, and continuously updating common taste musical information through the processes of extracting and matching the musical taste of the user with the musical taste of the friend.

Second, it is possible to provide various customized music services by analyzing musical information possessed by friends, and reconfiguring the analyzed musical information as musical information having a high correlation with a user taste.

Third, it is possible to activate use of musical information by recommending various kinds of music by using friend information, and continuously reflecting the preferences for corresponding music while listening to the music.

Fourth, it is possible to achieve a high-quality audio video navigation (AVN) system by installing the music streaming service of the present inventive concept in a vehicular multimedia system within a vehicle as a sort of services.

Other aspects and preferred embodiments of the inventive concept are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the inventive concept are discussed infra.

### BRIEF DESCRIPTION OF THE DRAWINGS

The above and other features of the present inventive concept will now be described in detail with reference to certain exemplary embodiments thereof illustrated in the accompanying drawings which are given hereinbelow by way of illustration only, and thus are not limitative of the present inventive concept.

FIG. 1 is a diagram illustrating a configuration of a device for providing a personalized music streaming service by using social networking according to an embodiment of the present inventive concept, and a service flow in the configuration.

FIG. 2 is a flowchart illustrating a series of execution processes of a method of providing a personalized music streaming service by using social networking according to an embodiment of the present inventive concept.

FIG. 3 is a flowchart illustrating information matching and extracting processes in a method of providing a personalized music streaming service by using social networking according to an embodiment of the present inventive concept in detail.

FIG. 4 is a diagram illustrating an exemplary embodiment of a method of providing a personalized music streaming service by using social networking according to an embodiment of the present inventive concept.

It should be understood that the appended drawings are not necessarily to scale, presenting a somewhat simplified representation of various preferred features illustrative of the basic principles of the inventive concept. The specific design features of the present inventive concept as disclosed herein, including, for example, specific dimensions, orientations, locations, and shapes will be determined in part by the particular intended application and use environment.

In the figures, reference numbers refer to the same or equivalent parts of the present inventive concept throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that the present description is not intended to limit the inventive concept to those exemplary embodiments. On the contrary, the inventive concept is intended to cover not only the exemplary embodiments, but also various alternatives, modifications, equivalents and other embodiments, which may be included within the spirit and scope of the inventive concept as defined by the appended claims.

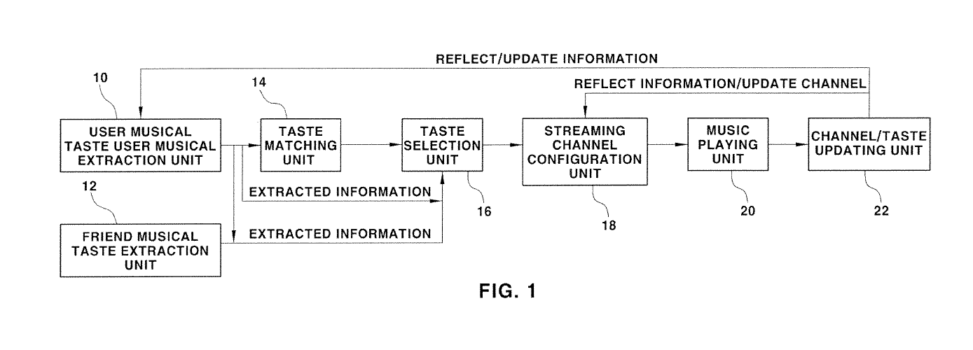

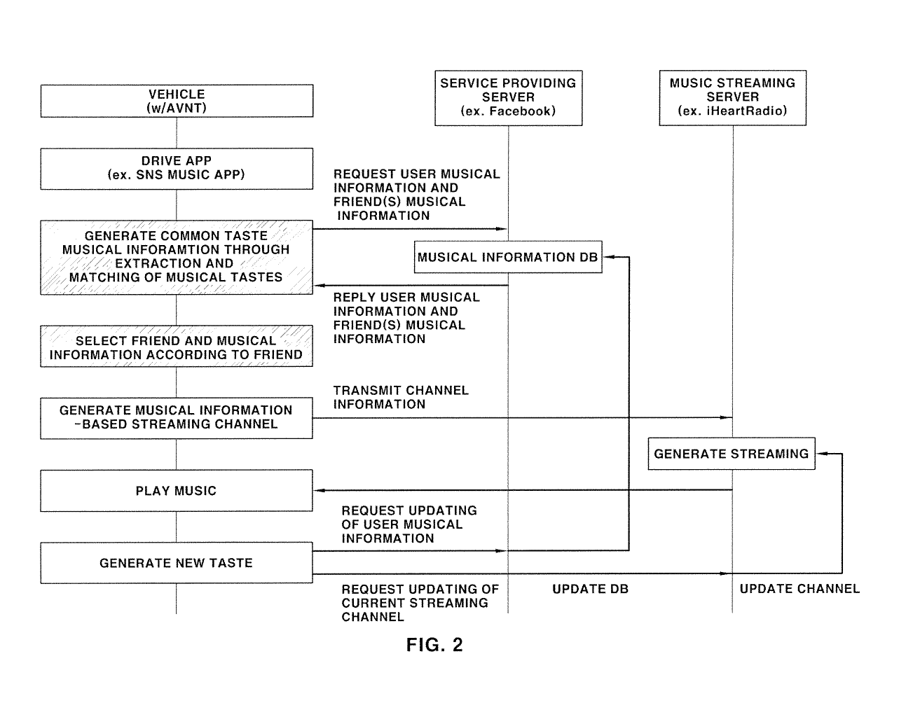

FIG. 1 is a diagram illustrating a configuration of a device for providing a personalized music streaming service by using social networking according to an embodiment of the present inventive concept, and FIG. 2 is a flowchart illustrating a series of execution processes of a method of providing a personalized music streaming service by using social networking according to an embodiment of the present inventive concept.

First, referring to FIG. 1, a dedicated application (app) for a personalized music streaming service according to an embedment of the present inventive concept may be downloaded and installed in an AVN system of a vehicle. Subsequently, the dedicated app may be driven and simultaneously, a user musical taste extraction unit 10 may perform an operation of analyzing and extracting musical taste information about a user.

That is, when the user listens to music by connecting a medium, such as a Universal Serial Bus (USB), to the AVN system of a vehicle, the user musical taste extraction unit 10 may analyze musician information (e.g., information on artists), a name of music, a genre (e.g., sound source mood), the music recently listened, the number of times of playing/repetition, and the like, to extract the musical taste of the user. The user musical taste extraction unit 10 may further, analyze information (e.g., preferred musician, music, genre, etc.) about music searched or tagged according to a connection to a social networking service by the user to extract the musical taste information of the user.

Further, a friend musical taste extraction unit 12 may perform an operation of extracting musical taste information of a friend of the user connected through the social networking service, together with the driving of the dedicated app.

More particularly, the friend musical taste extraction unit 12 may analyze information on the friend connected through the social networking service and information on the music shared by the friend (e.g., information on a preferred artist or musician, a name of music, a genre or sound source mood, and the like) to extract the musical taste of the friend. The friend musical taste extraction unit 12 may further, analyze musical information application searched or tagged by the friend in the social networking service to extract the musical taste information about the friend.

Next, a taste matching unit 14 of the dedicated app may perform an operation of comparing the musical taste information of the user and the musical taste information of the friend, and may perform an operation of extracting common musical taste information based on a result of the comparison.

That is, the taste matching unit 14 may compare the musical taste information of the friend with a result of the extraction of the musical taste of the user in an order of an artist, music, a genre, recently listened music, and the like to extract the common musical taste information.

In this case, the user musical information extracted by the user musical taste extraction unit 10, the friend musical information extracted by the friend musical taste extraction unit 12, and the common musical taste information extracted by the taste matching unit 14 may be stored in a musical information DB self-established in a service providing server (for example, a server possessing friend information in addition to a commercial social networking service like Facebook, as a social networking service server provided in an open API form).

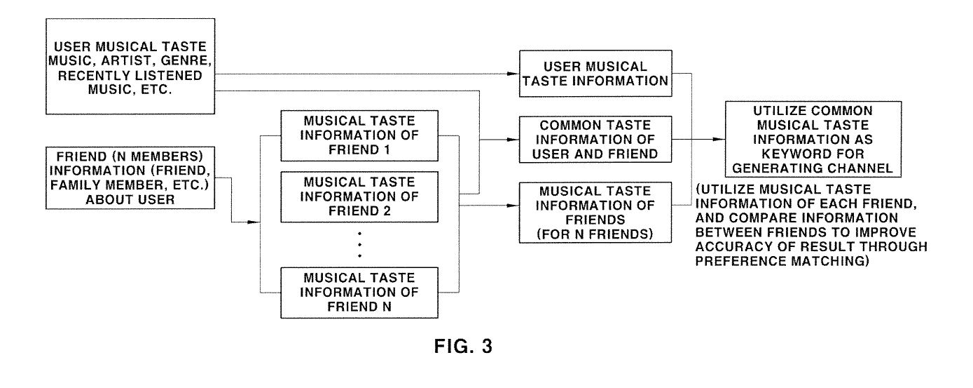

More particularly, as illustrated in FIG. 3, the user musical information (e.g., the artist, name and genre of music, the recently listened music, and the like) extracted by the user musical taste extraction unit 10, the musical taste information of friends 1 to N extracted by the friend musical taste extraction unit 12, and the common musical taste information extracted by the taste matching unit 14 may be stored in the musical information DB self-established in the service providing server (for example, a server possessing friend information in addition to a commercial social networking service like Facebook, as a social networking service server provided in an open API form) so as to be utilized as information for generating a music streaming channel (for example, keyword information).

Accordingly, the taste matching unit 14 may receive the user musical information and the friend musical information stored in the musical information DB in the social networking service server, perform an analysis and matching on the information, and then provide extracted common preferred music and common taste information to a taste selection unit 16 by which the user may select musical information.

Next, the user may select arbitrary musical information to be utilized for generating a streaming channel from the musical information (e.g., the common musical taste information) provided from the musical information DB through the taste selection unit 16 of the dedicated app.

Next, a channel configuration unit 18 of the dedicated app may perform an operation of configuring a streaming channel by utilizing the arbitrary musical information selected by the user from the common musical taste information.

For example, when the arbitrary musical information is selected from the common musical taste information between the user and the friend, the channel configuration unit 18 may generate the streamlining channel through which the user may listen to commonly preferred music. Even when the musical taste information preferred by the friend is selected or the musical taste information preferred by the user is selected, the channel configuration unit 18 may generate a separate streaming channel, e.g., separate channels for the music preferred by the fried and the music preferred by the user.

When information about the streaming channel generated by the channel configuration unit 18 is transmitted to a music streaming server (for example, a server of an Internet radio company), a new music streaming channel for playing the music may be completely generated.

Accordingly, the music streaming server receiving the channel information may generate the new music streaming channel, and provide music selected by the user to a music playing unit 20 through the new music streaming channel, so that the preferred music selected by the user is played through the music playing unit 20 of the dedicated app, thereby enabling the user to listen to the music.

In the meantime, a user's taste may be reflected by using an input button, and the like for inputting the user's taste in the music playing unit while streaming music through the music streaming channel.

That is, a channel/taste updating unit 22 of the dedicated app may adjust a sound source tendency of the previously generated channel by reflecting the inputted user's taste, and transmit the inputted user's taste to the user musical taste extraction unit 10 through the musical information DB to update the user musical taste information, and may compare the updated user musical taste information and the musical taste information of the friend to extract common musical taste information again.

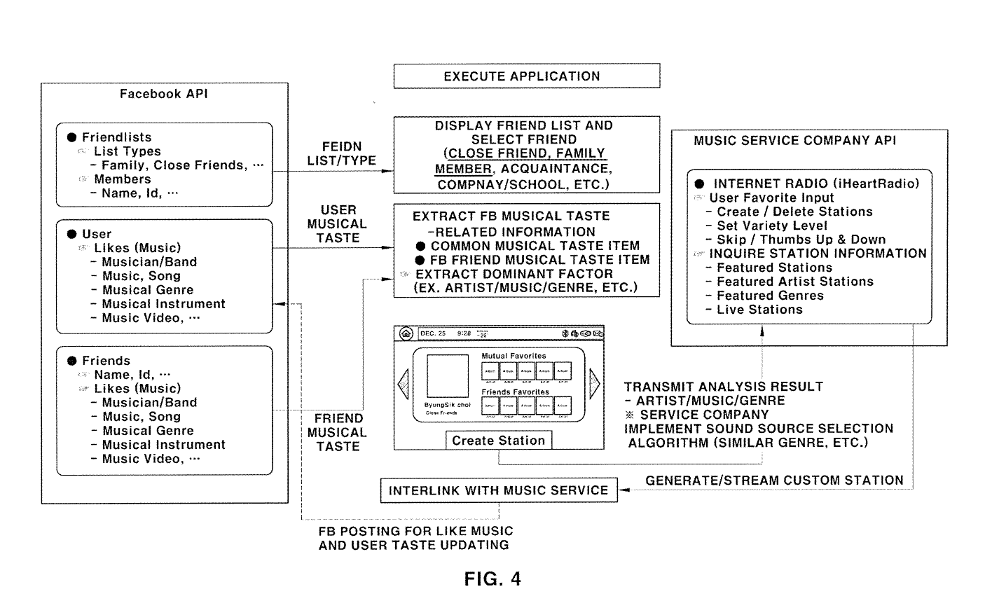

The aforementioned device and method of providing a personalized music streaming service by using social networking according to an embodiment of the present inventive concept will be organized and described again below with reference to FIG. 4.

When a social network service server (for example, Facebook) is connected and communicated with a dedicated app installed within a vehicle, musical taste information of each friend included in a friend list and a friend type, and the user musical taste information may be transmitted from the social network service server to the dedicated app installed within the vehicle.

Next, the user musical taste information extracted by the user musical taste extraction unit 10 of the dedicated app may be compared with the friend musical taste information extracted by the friend musical taste extraction unit 12 to analyze and extract the common musical taste information as a dominant factor.

As illustrated in FIG. 4, the extracted musical taste information may be divided into mutual favorites, the user's favorites, and/or the friends' favorites, etc., on a screen image of the dedicated app and separately displayed, and the extracted musical information may be transmitted to a music streaming server (for example, an API of a music service company, such as an Internet radio) as information for generating a channel.

Accordingly, the music streaming server may generate new music streaming channels for playing music as represented in an example below.

User Favorite Input
Create Stations/Delete Stations
Set Variety Level
Skip/Thumbs/Up & Down

Inquire station information
Featured Stations
Featured Artist Stations
Featured Genres
Live Stations

The music streaming service may be provided to and played by the music playing unit of the dedicated app through the generated new music streaming channel, thereby enabling a user to listen to preferred music.

The inventive concept has been described in detail with reference to preferred embodiments thereof. However, it will be appreciated by those skilled in the art that changes may be made in these embodiments without departing from the principles and spirit of the inventive concept, the scope of which is defined in the appended claims and their equivalents.

What is claimed is:

1. A device for providing a personalized music streaming service by using a social networking service, comprising:
a user musical taste extraction unit configured to analyze and extract musical taste information of a user;
a friend musical taste extraction unit configured to extract musical taste information of a friend connected through the social networking service; and
a taste matching unit configured to compare the musical taste information of the user with the musical taste information of the friend, extract common musical taste information based on a result of the comparison, and match the musical taste information of the user with the musical taste information of the friend.

2. The device of claim 1, further comprising:
a channel configuration unit configured to generate and configure a streaming channel by utilizing the common musical taste information; and
a music playing unit configured to execute and provide a music streaming by selecting the channel generated and configured by the channel configuration unit.

3. The device of claim 1, further comprising:
a database (DB) storing the musical information extracted by the user musical taste extraction unit, the friend musical taste extraction unit, and the taste matching unit; and
a taste selection unit configured to select musical information to be utilized for generating a streaming channel from the musical information stored in the DB.

4. The device of claim 2, further comprising:
a channel/taste updating unit configured to adjust a sound source tendency of the channel generated and configured by the channel configuration unit by reflecting a taste of the user while streaming music through the channel, transmit the taste of the user to the user musical taste extraction unit, and update the taste of the user.

5. The device of claim 2, further comprising:
a music streaming server configured to generate a music streaming based on information about the channel generated and configured by the channel configuration unit, and provide the generated music streaming to the music playing unit.

6. A method of providing a personalized music streaming service by using a social networking service, comprising:
analyzing and extracting, by a user musical taste extraction unit, musical taste information of a user;
extracting, by a friend musical taste extraction unit, musical taste information of a friend connected through the social networking service;
comparing, by a taste matching unit, the musical taste information of the user and the musical taste information of the friend, extracting common musical taste information based on a result of the comparison, and matching the musical taste information of the user with the musical taste information of the friend;
generating and configuring a streaming channel by utilizing the common musical taste information; and
selecting the generated and configured channel, executing a music streaming, and playing music.

7. The method of claim 6, further comprising:
storing, in a database (DB), the musical information extracted by the user musical taste extraction unit, the friend musical taste extraction unit, and the taste matching unit; and
selecting musical information to be utilized for generating a streaming channel from the musical information stored in the DB.

8. The method of claim 6, further comprising: adjusting a sound source tendency of the channel generated and configured by the channel configuration unit by reflecting a taste of the user while streaming music through the channel, transmitting the taste of the user to the user musical taste extraction unit, and updating the taste of the user.

9. The method of claim 6, wherein the playing of the music includes generating a new music streaming channel in a music streaming server receiving channel information, and providing and playing music selected by the user through the new music streaming channel.

10. The method of claim 6, wherein the matching of the musical taste information of the user with the musical taste information of the friend includes comparing the musical taste information of the user and the musical taste information of the friend in an order of an artist, music, a genre, and recently listened music.
